(19) United States
(12) Patent Application Publication
(10) Pub. No.: US 2009/0154628 A1
(43) Pub. Date: Jun. 18, 2009

(54) SCAN SIGNAL GENERATING CIRCUIT AND SCAN SIGNAL GENERATING METHOD THEREOF

(75) Inventors: Yan-Jou Chen, Taoyuan County (TW); Yu-Chiung Yeh, Taoyuan County (TW); Hung-Jen Wang, Taipei County (TW); Yu-Ting Chen, Taoyuan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: HANNSTAR DISPLAY CORP., Tao-Yuan Hsien (TW)

(21) Appl. No.: 12/020,601

(22) Filed: Jan. 28, 2008

(30) Foreign Application Priority Data
Dec. 12, 2007 (TW) 96147381

(51) Int. Cl. H04L 7/00

(52) U.S. Cl. 375/371; 345/214

(57) ABSTRACT

The invention provides scan signal generating circuits and scan signal generating methods thereof. The scan signal generating circuit comprises a first, a second and a third switch and a capacitor, and generates a scan signal driving a pixel. The first switch is turned on to couple an input signal to a first node when a first clock signal is high. The second switch, controlled according to the voltage level at the first node, is turned on to couple a second clock signal that has an inverse phase of the first clock signal to an output terminal of the scan signal generating circuit when the voltage level at the first node is high. When the first clock signal is high, the third switch is turned on to couple the output terminal to a first voltage source. The first node is coupled to ground by the capacitor.

### BACKGROUND OF THE INVENTION

1. Field of the Invention

The present invention relates to scan signal generating circuits and the scan signal generating methods thereof, and particularly relates to scan signal generating techniques for display devices.

2. Description of the Related Art

A display device comprises a pixel array. The pixels in each row are driven by the same scan signal and the pixels of each column share one data line. To display a frame of image, the pixel array is driven row by row from top to bottom. The enabled pixels display the data transmitted on the data lines. To display video, the pixel array is repeatedly driven.

FIG. 1 illustrates a conventional scan signal generating circuit, also known as a Thomson circuit. The circuit comprises a plurality of NMOS transistors 102˜108 and capacitors 110 and 112. Symbols IN, OUT, RES and COM represent an input terminal of the circuit, an output terminal of the circuit, a reset signal and a common voltage level, respectively. Symbols CLK1 and CLK2 represent two different clock signals.

The input terminal IN receives a pulse having the same enable interval with the clock signal CLK1. The clock signals CLK1 and CLK2 have different enable intervals. When CLK1 is high and CLK2 is low, the voltage levels of the gate and source of the NMOS transistor 104 are kept by capacitors 110 and 112 respectively, thus, the NMOS transistor 104 is kept turned on. At this moment, when the clock signal CLK2 switches to high, the signal at the output terminal OUT follows the voltage level of CLK2 and rises to high. When the conventional scan signal generating circuit is applied in pixel array driving, the input terminal IN is used for receiving a scan signal generated by the previous stage and the signal at the output terminal OUT is used for driving a row of pixels corresponding to the present stage.

In the conventional technique shown in FIG. 1, two passive capacitors 110 and 112 are required. The passive capacitors 110 and 112 are usually large-sized and there is serious noise at the output terminal OUT. The conventional techniques are relatively expensive.

### BRIEF SUMMARY OF THE INVENTION

The invention provides scan signal generating circuits and scan signal generating methods thereof. The scan signal generating circuit comprises a first switch, a second switch, a third switch, and a capacitor. The first switch has a first terminal receiving an input signal, a second terminal coupled to a first node, and a control terminal receiving a first clock signal. The first switch is turned on when the first clock signal is high. The second switch has a first terminal receiving a second clock signal, a second terminal coupled to a second node and a control terminal coupled to the first node. The second switch is turned on when the voltage level at the first node is high. The second clock signal has an inverse phase of the first clock signal. The third switch has a first terminal coupled to the second node, a second terminal coupled to a first voltage source, and a control terminal receiving the first clock signal. The third switch is turned on when the first clock signal is high. The capacitor is coupled between the second node and ground. In an embodiment of the invention, the signal at the second node is a scan signal for driving a row of pixels corresponding to the scan signal generating circuit, and the second node is coupled to an output terminal of the scan signal generating circuit to output the scan signal. In another embodiment according to the invention, the scan signal generating circuit further comprises a buffer, used for preventing signal coupling between the signals of the present scan signal generating circuit and the signals of the next scan signal generating circuit.

In another embodiment according to the invention, the scan signal generating circuit comprises a first switch, a second switch, a third switch, and a fourth switch. The first switch has a first terminal receiving an input signal, a second terminal coupled to a first node, and a control terminal receiving a first clock signal. The first switch is turned on when the first clock signal is high. The second switch has a first terminal receiving a second clock signal, a second terminal coupled to a second node, and a control terminal coupled to the first node. The second switch is turned on when the voltage level at the first node is high. The second clock signal has an inverse phase of the first clock signal. The third switch has a first terminal coupled to a first voltage source, a second terminal coupled to a third node, and a control terminal coupled to the second node. The third switch is tuned on when the voltage level at the second node is high. The fourth switch has a first terminal coupled to the third node, a second terminal coupled to a second voltage source providing a voltage lower than that provided by the first voltage source, and a control terminal receiving the first clock signal. The fourth switch is turned on when the first clock signal is high.

The invention further discloses methods generating scan signals by the scan signal generating circuits according to the invention. The scan signal generating circuit comprises a first switch, a second switch, a third switch, and a first capacitor. The scan signal generating method comprises: coupling a first clock signal to the first switch and, when the first clock is at the enable state, turning on the first switch to couple an input signal to a first node; controlling the second switch by the voltage level at the first node and, when the voltage level at the first node is at the enable state, turning on the second switch to couple a second clock that has an inverse phase of the first clock signal to a second node; controlling the third switch by the first clock signal and, when the first clock signal is at the enable state, turning on the third switch to couple the second node to a first voltage source; and coupling the first node to ground by the first capacitor.

The invention further discloses another scan signal generating method using the scan signal generating circuits according to the invention. The scan signal generating circuit comprises a first switch, a second switch, a third switch and a fourth switch. The scan signal generating method comprises: coupling a first clock signal to the first switch and, when the first clock signal is at the enable state, turning on the first switch to couple an input signal to a first node; controlling the second switch according to the voltage level at the first node and, when the voltage level at the first node is at enable state, turning on the second switch to couple a second clock signal that has an inverse phase of the first clock signal to a second node; controlling the third switch according to the voltage level at the second node and, when the voltage level at the second node is at the enable state, turning on the third switch to couple a third node to a first voltage source; and coupling the first clock signal to the fourth switch and, when the first clock signal is at the enable state, turning on the fourth switch to couple the third terminal to a second voltage source having lower voltage level than the first voltage source.

The above and other advantages will become more apparent with reference to the following description taken in conjunction with the accompanying drawings.

### BRIEF DESCRIPTION OF THE DRAWINGS

The invention can be more fully understood by reading the subsequent detailed description and examples with references made to the accompanying drawings, wherein:

FIG. 1 illustrates a conventional scan signal generating circuit, also known as a Thomson circuit;

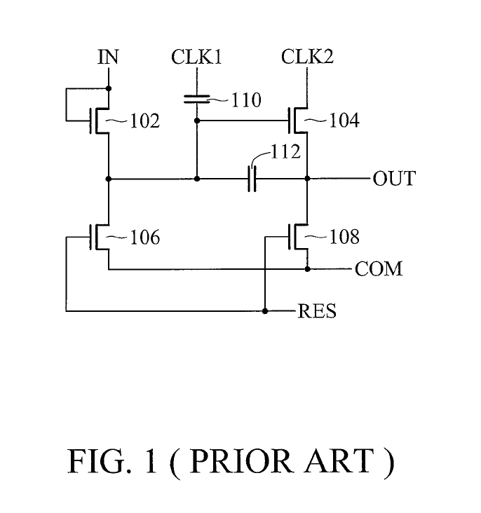

FIG. 2 illustrates an embodiment of the scan signal generating circuit according to the invention;

FIG. 3 shows several waveforms describing the relationship between the input signal and the output signal of the scan signal generating circuit according to the invention;

FIG. 4 illustrates another embodiment of the scan signal generating circuit according to the invention;

FIG. 5 illustrates another embodiment of the scan signal generating circuit according to the invention;

FIG. 6 illustrates another embodiment of the scan signal generating circuit according to the invention;

FIG. 7 illustrates an embodiment of the scan signal generating device according to the invention;

FIG. 8 illustrates another embodiment of the scan signal generating device according to the invention; and

FIG. 9 illustrates another embodiment of the scan signal generating device according to the invention.

### DETAILED DESCRIPTION OF THE INVENTION

The following description shows some embodiments carrying out the invention. This description is made for the purpose of illustrating the general principles of the invention and should not be taken in a limiting sense. The scope of the invention is best determined by reference to the appended claims.

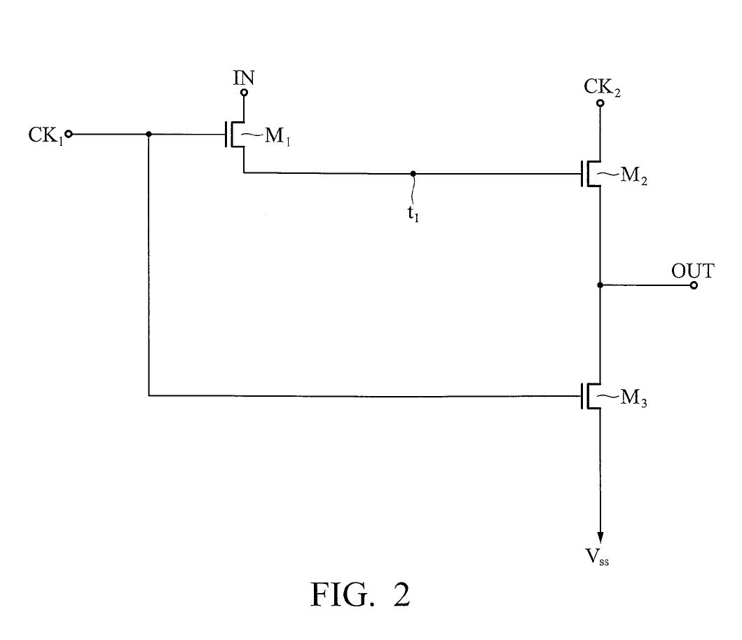

FIG. 2 illustrates an embodiment of the scan signal generating circuit according to the invention, and the following describes the structure and the scan signal generating method thereof. The scan signal generating circuit comprises a first switch M₁, a second switch M₂ and a third switch M₃. When the scan signal generating circuit is applied in a display device, such as a liquid crystal display, the output terminal OUT outputs a scan signal for a row of pixels. The first switch M₁ is controlled by a first clock signal CK₁. When the first clock signal CK₁ is high (enable state), the first switch M₁ is turned on to couple an input signal IN to a first node t₁. The second switch M₂ is controlled by the voltage level at the first node t₁. When the voltage level at the first node t₁ is high (enable state), the second switch M₂ is turned on to couple a second clock signal CK₂ to the output terminal OUT. The second clock signal CK₂ is designed to have an inverse phase of the first clock signal CK₁. The third switch M₃ is coupled between a low voltage source Vₛₛ and the output terminal OUT and is controlled by the first clock signal CK₁. When the first clock signal CK₁ is high, the output terminal OUT is coupled to the low voltage source Vₛₛ by the third switch M₃.

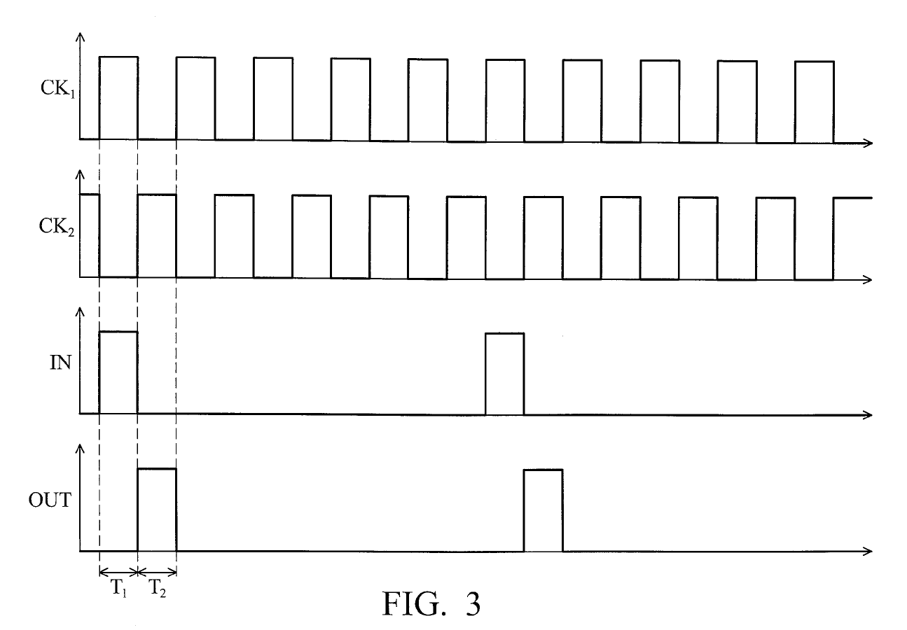

FIG. 3 shows several waveforms describing the relationship between the input signal and the output signal of the scan signal generating circuit according to the invention. The input signal IN is high only during time interval T₁, and is kept at low during the other time intervals. As shown in FIG. 3, the first clock signal CK₁ is high during the time interval T₁ so that the first switch M₁ is turned on to couple the high input signal to the first node t₁ to turn on the second switch M₂. Because the second switch M₂ is turned on at this moment (time interval T₁), the second clock signal CK₂ which has an inverse phase of the first clock signal CK₁ is low during time interval T₁ is coupled to the output terminal OUT. Thus, the signal of the output terminal OUT is low during time interval T₁. The first clock signal CK₁ also turns on the third switch M₃ during the first time interval T₁, so that the output signal OUT is forced to a low voltage level provided by the low voltage source Vₛₛ during the first time interval T₁. During the second time interval T₂, the first clock signal CK₁ is low so that the first switch M₁ is turned off. The voltage level at the first node t₁ is kept at high (as it were during time interval T₁) by the parasitic capacitor of the second switch M₂. Thus, the second switch M₂ is still turned on by the high voltage level at the first node t₁, and the second clock signal CK₂ which is high during the second time interval T₂ is coupled to the output terminal OUT. As shown in FIG. 3, the signal of the output signal OUT is high during the second time interval T₂, and the signal of the output signal OUT is the delayed signal of the input signal IN.

The switches mentioned in the invention may be realized by Thin Film Transistors (TFTs) or other semiconductor components. Compared with conventional scan signal generating circuits, the embodiment shown in FIG. 2 dramatically decreases the amount of transistors and capacitors so that the circuit size is dramatically reduced. Furthermore, the scan signal generating circuit according to the invention only requires the output signal of the previous stage to work as the input signal of the present stage. Compared to conventional techniques that further require a feedback signal provided by the next stage, the invention is simpler.

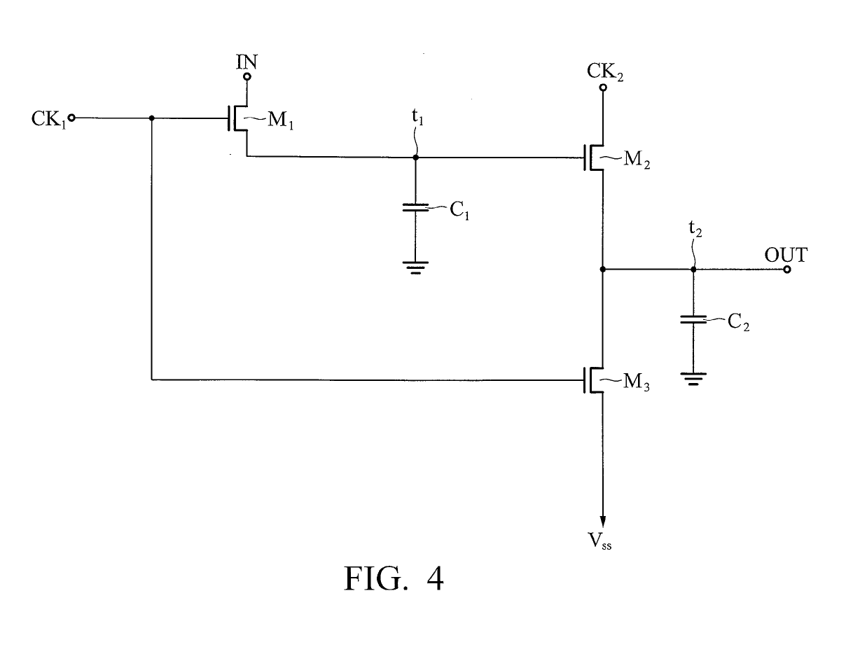

Because the scan signal generating circuit is used for generating a scan signal to drive pixels to receive data, the TFT size has to be quite large. However, large-sized TFT has great parasitic capacitors (such as C_{gs} and C_{gd}) and signal coupling is generated by the great parasitic capacitors, so that the output signal OUT varies with the clock signals CK₁ and CK₂. To reduce the signal coupling effect, the invention further discloses a scan signal generating circuit shown and illustrated in an embodiment thereof as shown in FIG. 4. Compared to FIG. 2, the circuit shown in FIG. 4 further comprises a first capacitor C₁ and a second capacitor C₂. The first capacitor C₁ is coupled between the first node t₁ and ground. The second capacitor C₂ is coupled between a second node t₂ and ground. The second node t₂ is allocated between the second switch M₂, the third switch M₃ and the output terminal OUT. In some embodiments according to the invention, the scan signal generating circuit may only comprise the first capacitor C₁.

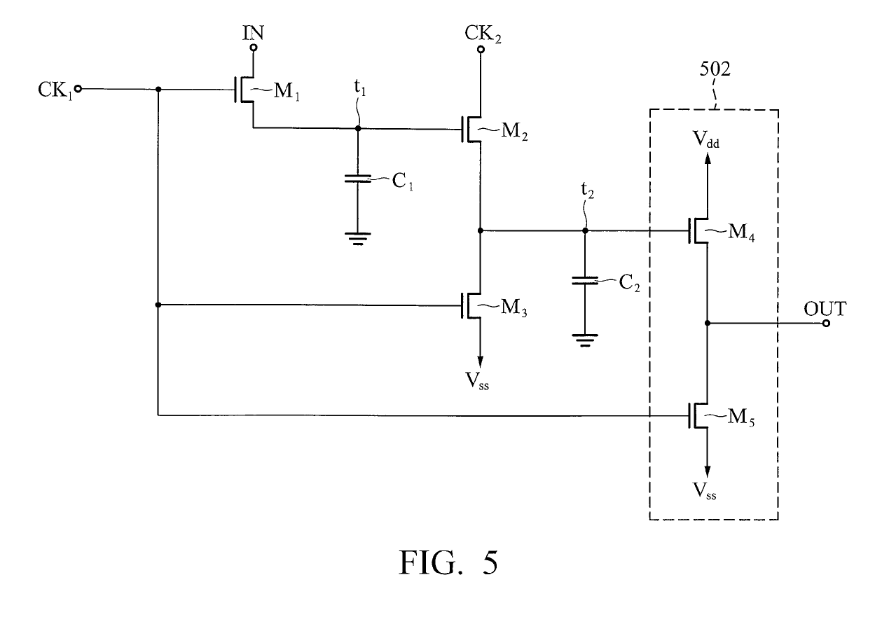

FIG. 5 illustrates another embodiment of the scan signal generating circuit according to the invention, which prevents the output signal of the present stage from being affected by the first clock signal CK₁ controlling the first switch of the next stage. The following describes the structure of the circuit and the scan signal generating method thereof. Compared to the circuit shown in FIG. 4, the circuit of FIG. 5 further comprises a buffer 502. Referring to FIG. 5, a second switch M₂ and a third switch M₃ is connected at a second node t₂. There is a buffer 502 coupling the second node t₂ to the output terminal OUT. The buffer 502 comprises a fourth switch M₄ and a fifth switch M₅. The fourth switch M₄ comprises a first terminal coupled to a high voltage source V_{dd}, a second terminal coupled to the output terminal OUT and a control terminal coupled to the second node t₂. The fourth switch M₄ is turned on when the voltage level at the second node t₂ is high. The fifth switch M₅ comprises a first terminal coupled to the output terminal OUT, a second terminal coupled to a low voltage source Vₛₛ and a control terminal receives the first clock signal CK₁. The fifth switch M₅ is turned on when the first clock signal CK₁ is high.

Referring to FIG. 5, the second node t₂ may be coupled to the input terminal of the scan signal generating circuit of the next stage as the input signal thereof. The signal of the output terminal OUT has being processed by the buffer 502 and works as the scan signal actually driving the row of pixels corresponding to this stage. In some other embodiments, the signal of the output terminal OUT (being processed by the buffer 502) is transmitted to the next stage as the input signal of the next stage, and the signal at the second node t₂ works as the scan signal driving the row of pixels corresponding to the present stage.

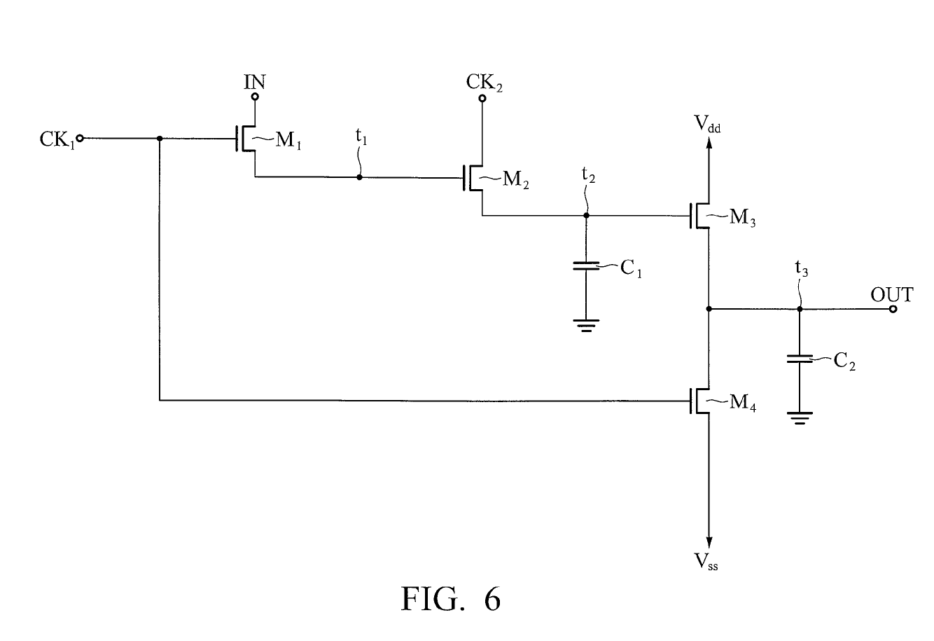

FIG. 6 illustrates another embodiment of the scan signal generating circuit according to the invention, which provides a scan signal with good pixel driving ability. The following describes the structure of the circuit and the scan signal generating method thereof. The scan signal generating circuit shown in FIG. 6 comprises a first switch M₁, a second switch M₂, a third switch M₃ and a fourth switch M₄. The first switch M₁ comprises a first terminal receiving an input signal IN, a second terminal coupled to a first node t₁ and a control terminal receiving a first clock signal CK₁. When the first clock signal CK₁ is high (enable state), the first switch M₁ is turned on to couple the input signal IN to the first node t₁. The second switch M₂ comprises a first terminal receiving a second clock signal CK₂, a second terminal coupled to a second node t₂ and a control terminal coupled to the first node t₁. When the voltage level at the first node t₁ is high, the second switch M₂ is turned on to couple the second clock signal CK₂ to the second node t₂. The second clock signal CK₂ is designed to have an inverse phase of the first clock signal CK₁. The third switch M₃ comprises a first terminal coupled to a high voltage source V_{dd}, a second terminal coupled a third node t₃ and a control terminal coupled to the second node t₂. When the voltage level at the second node t₂ is high, the third switch M₃ is turned on to raise the voltage level at the third node t₃ to the high voltage level provided by the high voltage source V_{dd}. The fourth switch M₄ comprises a first terminal coupled to the third node t₃, a second terminal coupled to a low voltage source Vₛₛ and a control terminal receiving the first clock signal CK₁. When the first clock signal CK₁ is high, the fourth switch M₄ is turned on to pull the voltage level of the third node t₃ to the low voltage level provided by the low voltage source Vₛₛ. In the embodiment shown in FIG. 6, the signal at the third node t₃ is applied in driving a row of pixels corresponding to this scan signal driving circuit. This embodiment provides good pixel driving ability by making the voltage level of high output signals approximate the high voltage level provided by the high voltage source V_{dd}.

In the embodiment shown in FIG. 6, the first capacitor C₁ is coupled between the second node t₂ and ground, and the second capacitor C₂ is coupled between the third node t₃ and ground.

The aforementioned switches may be realized by TFTs or other semiconductor components.

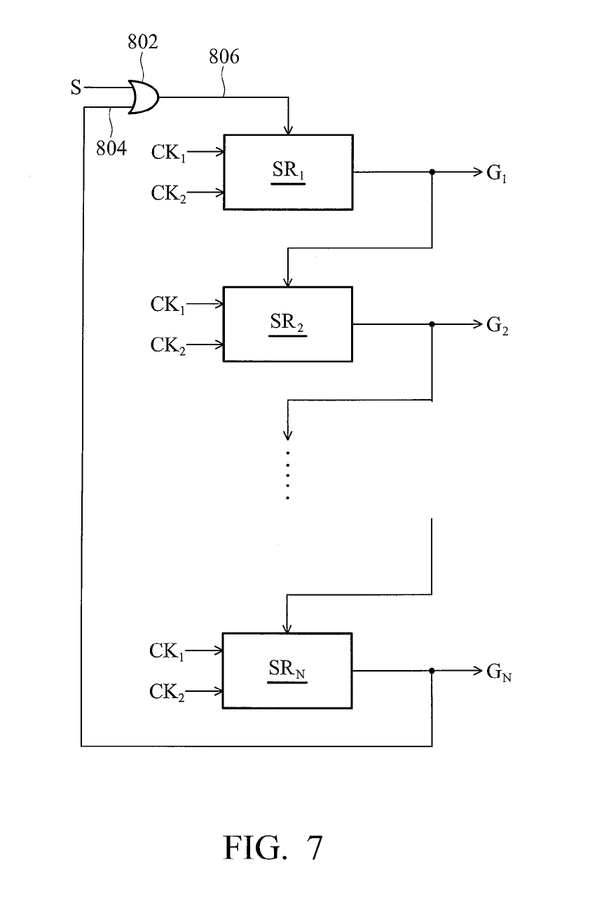

The invention further discloses a scan signal generating device comprising a plurality of scan signal generating circuits according to the invention. FIG. 7 illustrates an embodiment of the scan signal generating device, which comprises a logic gate 802 and a plurality of scan signal generating circuits SR₁˜SR_{N}. The logic gate 802 receives a start signal S and a feedback signal 804 and generates a frame refresh signal 806. The frame refresh signal 806 is high when the start signal S or the feedback signal 804 is high. The logic gate 802 may be an OR gate. The scan signal generating circuits SR₁˜SR_{N} may be realized by the circuits shown in FIG. 2, 4 or 6. The frame refresh signal 806 is sent into the first scan signal generating circuit SR₁ as the input signal IN thereof. The feedback signal 804 is the output signal of the last scan signal generating circuit SR_{N} directly.

To start display images, the CPU sends out a pulse as the start signal S. Thus, a pulse occurs in the frame fresh signal 806. The scan signal generating circuit SR₁ delays the pulse to generate a scan signal G₁ for the first row of the pixel array. The scan signal G₁ is inputted into the second scan signal generating circuit SR₂ and delayed by SR₂ to generate a scan signal G₂ for the second row of the pixel array. Similarly, the scan signal G_{N-1} driving the (N-1)th row of pixels is delayed by the last scan signal generating circuit SR_{N} to generate a scan signal G_{N} for the last row of the pixel array. The scan signals G₁˜G_{N} sequentially drive the rows of pixels to display a frame. The Nth scan signal G_{N} for the Nth row is fed back to the logic gate 802 as the feedback signal 804 so that a pulse occurs at the frame refresh signal 806 again and the scan signal generating circuits SR₁˜SR_{N} generates another set of scan signals G₁˜G_{N} to drive the pixel array to display another frame of image.

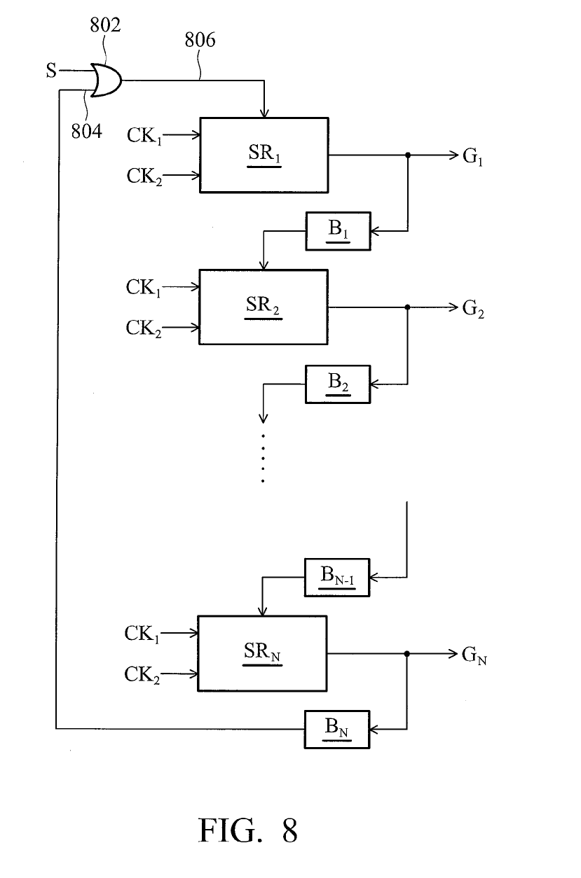

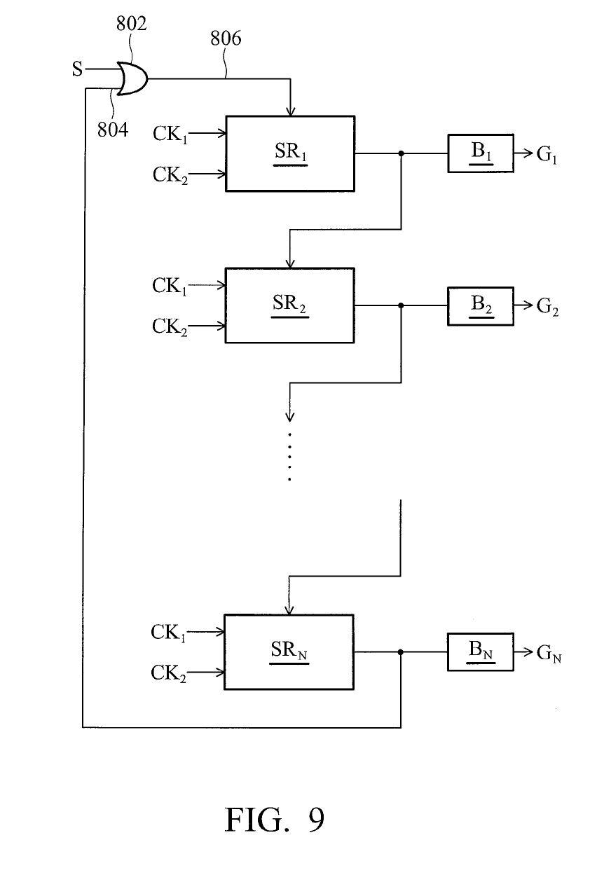

To prevent the output signal of the present stage from being affected by the first clock signal CK₁ at the control terminal of the first switch M₁ of the next stage, the embodiment shown in FIG. 8 further provides a plurality of buffers B₁˜B_{N} Before being sent into the next stages, the scan signals G₁˜G_{N} are processed by their corresponding buffers B₁˜B_{N} FIG. 9 illustrates another embodiment of the scan signal generating device. In this embodiment, the output of the scan signal generating circuits SR₁˜SR_{N} are further processed by their corresponding buffers B₁˜B_{N} before driving their corresponding pixels, The buffers B₁˜B_{N} may be implemented by the buffer 502 shown in FIG. 5.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded to the broadest interpretation so as to encompass all such modifications and similar arrangements.

What is claimed is:

1. A scan signal generating circuit, comprising:
a first switch, comprising a first terminal receiving an input signal, a second terminal coupled to a first node and a control terminal receiving a first clock signal, and being turned on when the first clock signal is high;
a second switch, comprising a first terminal receiving a second clock signal which has an inverse phase of the first clock signal, a second terminal coupled to a second node and a control terminal coupled to the first node, and being turned on when the voltage level at the first node is high;
a third switch, comprising a first terminal coupled to the second node, a second terminal coupled to a first voltage source and a control terminal receiving the first clock signal, and being turned on when the first clock signal is high; and
a first capacitor, coupling the first node to ground.

2. The scan signal generating circuit as claimed in claim 1, wherein the second node is coupled to an output terminal of the scan signal generating circuit.

3. The scan signal generating circuit as claimed in claim 2, further comprising a second capacitor coupling the second node to the ground.

4. The scan signal generating circuit as claimed in claim 1, further comprising a buffer comprising:
a fourth switch, comprising a first terminal coupled to a second voltage source, a second terminal coupled to an output terminal of the scan signal generating circuit and a control terminal coupled to the second node, and being turned on when the voltage level at the second node is high; and
a fifth switch, comprising a first terminal coupled to the output terminal, a second terminal coupled to the first voltage source and a control terminal receiving the first clock signal, and being turned on when the first clock signal is high.

5. The scan signal generating circuit as claimed in claim 4, further comprising a second capacitor coupling the second node to the ground.

6. The scan signal generating circuit as claimed in claim 4, wherein the voltage level provided by the first voltage source is lower than the voltage level provided by the second voltage source.

7. A scan signal generating circuit, comprising:
a first switch, comprising a first terminal receiving an input signal, a second terminal coupled to a first node and a control terminal receiving a first clock signal, and being turned on when the first clock signal is high;
a second switch, comprising a first terminal receiving a second clock signal which has an inverse phase of the first clock signal, a second terminal coupled to a second node and a control terminal coupled to the first node, and being turned on when the voltage level at the first node is high;
a third switch, comprising a first terminal coupled to a first voltage source, a second terminal coupled to a third node and a control terminal coupled to the second node, and being turned on when the voltage level at the second node is high; and
a fourth switch, comprising a first terminal coupled to the third node, a second terminal coupled to a second voltage source and a control terminal receiving the first clock signal, and being turned on when the first clock signal is high.

8. The scan signal generating circuit as claimed in claim 7, wherein the third node is coupled to an output terminal of the scan signal generating circuit.

9. The scan signal generating circuit as claimed in claim 8, further comprising a first capacitor coupling the second node to ground and a second capacitor coupling the third node to ground.

10. The scan signal generating circuit as claimed in claim 7, wherein the voltage level provided by the first voltage source is higher than the voltage level provided by the second voltage source.

11. A scan signals generating method using a scan signal generating circuit comprising a first switch, a second switch, a third switch and a first capacitor, the method comprising:
coupling a first clock signal to the first switch and, when the first clock signal is at an enable state, turning on the first switch to couple an input signal to a first node;
controlling the second switch according to the voltage level at the first node and, when the voltage level at the first node is at the enable state, turning on the second switch to couple a second clock signal having an inverse phase of the first clock signal to a second node;
controlling the third switch by the first clock signal and, when the first clock signal is at the enable state, turning on the third switch to couple the second node to a first voltage source; and
coupling the first node to ground by the first capacitor.

12. The scan signals generating method as claimed in claim 11, further comprising coupling the second node to an output terminal of the scan signal generating circuit.

13. The scan signals generating method as claimed in claim 12, further comprising providing a second capacitor coupling the second node to the ground.

14. The scan signals generating method as claimed in claim 11, further comprising providing a fourth switch, wherein the fourth switch comprises a first terminal coupled to a second voltage source, a second terminal coupled to an output terminal of the scan signal generating circuit and a control terminal coupled to the second node, and is turned on when the voltage level at the second node is at the enable state.

15. The scan signals generating method as claimed in claim 14, further comprising providing a fifth switch, wherein the fifth switch comprises a first terminal coupled to the output terminal, a second terminal coupled to the first voltage source and a control terminal receiving the first clock signal, and is turned on when the first clock signal is at the enable state.

16. The scan signals generating method as claimed in claim 15, further comprising providing a second capacitor coupling the second node to the ground.

17. The scan signals generating method as claimed in claim 15, wherein the voltage level provided by the first voltage source is lower than the voltage level provided by the second voltage source.

18. A scan signal generating method using a scan signal generating circuit comprising a first switch, a second switch, a third switch and a fourth switch, and the method comprising:
coupling a first clock signal to the first switch and, when the first clock signal is at an enable state, turning on the first switch to couple an input signal to a first node;
controlling the second switch according to the voltage level at the first node and, when the voltage level at the first node is at the enable state, turning on the second switch to couple a second clock signal having an inverse phase of the first clock signal to a second node;
controlling the third switch according to the voltage level of at the second node and, when the voltage level at the second node is at the enable state, turning on the third switch to couple a third node to a first voltage source; and
coupling the first clock signal to the fourth switch and, when the first clock signal is enabled, turning on the fourth switch to couple the third node to a second voltage source.

19. The scan signal generating method as claimed in claim 18, further comprising coupling the third node to an output terminal of the scan signal generating circuit.

20. The scan signal generating method as claimed in claim 19, further comprising providing a first capacitor coupling the second node to ground and a second capacitor coupling the third node to the ground.

21. The scan signal generating method as claimed in claim 18, wherein the voltage level provided by the first voltage source is greater than the voltage level provided by the second voltage source.
